(19) United States
(12) Patent Application Publication
(10) Pub. No.: US 2015/0123913 A1
(43) Pub. Date: May 7, 2015

(54) APPARATUS AND METHOD FOR PRODUCING LATERAL FORCE ON A TOUCHSCREEN

(71) Applicant: Andrew Kerdemelidis, London (GB)

(72) Inventor: Andrew Kerdemelidis, London (GB)

(21) Appl. No.: 14/073,854

(22) Filed: Nov. 6, 2013

(51) Int. Cl. G06F 3/01; G06F 3/041

(52) U.S. Cl. CPC G06F 3/016; G06F 3/0414; G06F 2203/04105
USPC 345/173

(57) ABSTRACT

The present invention relates generally to an apparatus and method for producing lateral force on a touchscreen. The apparatus and method allows a lateral force to be produced and felt by an appendage that is touching or manipulating objects on the touchscreen by generating and modulating the surface friction presented to a finger on a touchscreen device or static control surface.

### FIELD OF THE INVENTION

The present invention relates generally to an apparatus and method for producing lateral force on a touchscreen.

Particularly, but not exclusively, the present invention relates generally to an apparatus and method for generating and modulating the surface friction presented to a finger on a touchscreen device or static control surface allowing a lateral force to be produced and felt by an appendage that is touching or manipulating objects on the touchscreen.

### BACKGROUND OF THE INVENTION

Recent advances in haptic feedback technology have resulted in the development of touchscreen displays that are able to present a feeling of ‘texture’ or vertical pressure and activity from the objects being displayed (refer to U.S. Pat. Nos. 7,924,144, 7,982,588, and 8,174,373 by Senseg Limited, which are hereby incorporated by reference). For example, this haptic feeback can be manipulated by under the principle of capacitative coupling, whereby an insulator between the skin and electrode can be used to create a localised sensation or feeling of pressure. These touchscreen displays are becoming more pervasive, and touch-actuated user interfaces are very popular in devices such as the Blackberry Playbook, the Apple iPad, iTouch and iPhone, and Android tablets. The problem with the displays on these devices, is that they do not provide any tangible lateral tactile feedback, and haptic technologies are primarily concerned with synthesizing the feeling of textures on the display, not in feeding back physical properties related to the inertia of an object on the touchscreen or the generation of a lateral force that can be felt by an appendage that is touching or manipulating objects on the display. There has been a lack of progress done to improve on mechanically coupled free-space haptic force feedback devices such as joysticks and remote surgery manipulators or indeed to incorporate the benefits of such lateral force haptic feedback into two-dimensional displays. Therefore, there is a need for an apparatus and method to overcome these deficiencies in the prior art.

### SUMMARY OF THE INVENTION

The present invention relates generally to an apparatus and method for producing lateral force on a touchscreen.

In a first aspect the invention provides an apparatus for producing a lateral force on a touchscreen comprising:

a touchscreen which can move to describe an oscillating line or shape in any lateral direction;
a processor configured to increase the friction coefficient between an object and said touchscreen when the net movement of said touchscreen occurs in a desired direction whereby a net lateral force in said desired direction may be produced upon an object in contact with said touchscreen.

In a second aspect the invention provides a method of producing a lateral force on a touchscreen including the steps of:

providing a touchscreen which can move to describe an oscillating line or shape in any lateral direction;
providing a processor configured to increase the friction coefficient between an object and said touchscreen when the net movement of said touchscreen occurs in a desired direction whereby a net lateral force in said desired direction may be produced upon an object in contact with said touchscreen.

In a third aspect the invention provides method of producing a lateral force on a touchscreen including the steps of:

providing an actuator configured to oscillate a touchscreen in a plurality of lateral directions substantially planar to the surface of said touchscreen at a variable frequency and amplitude;
providing a processor configured to vary the friction coefficient of least one area between the surface of said touchscreen and an object touching said touchscreen and to record and vary the frequency and amplitude of oscillation of said touchscreen and to control the lateral direction of movement of said touchscreen;
wherein said processor increases said friction coefficient when said touchscreen is substantially moving in a desired direction, whereby a lateral force in said desired direction may be produced upon an object contacting said touchscreen.

Preferably, said processor is configured to decrease or negate said friction coefficient when said touchscreen is moving in a direction other than desired direction.

Preferably, said actuator is configured to vibrate touchscreen in an ultrasonic manner in order to decrease or negate said friction coefficient.

By said processor substantially increasing said friction coefficient when said touchscreen is substantially moving in a desired direction and/or substantially decreasing or negating said friction coefficient when said touchscreen is substantially moving in any other direction, a substantially increased lateral force in the desired direction may be produced.

By said processor substantially increasing said frequency and/or amplitude of movement in said desired direction, a substantially increased lateral force in a desired direction may be produced upon an object contacting said touchscreen.

By said processor increasing the friction coefficient between a first object and said touchscreen within a first area on said touchscreen when the net movement of said touchscreen occurs in a desired direction on said first area and otherwise decreasing or negating said friction coefficient on said first area, and increasing the friction coefficient between a second object and said touchscreen within a second area on said touchscreen when the net movement of said touchscreen occurs in a desired direction on said second area and otherwise decreasing or negating said friction coefficient on said second area, desired lateral forces in independent directions can be produced upon said first object and said second object.

Preferably, said actuator is configured to oscillate said touchscreen in a substantially circular or elliptical or sinusoidal motion.

Preferably, when said actuator is configured to oscillate said touchscreen in a substantially circular or elliptical or sinusoidal motion, said friction coefficient is maximally increased proximal to the tangent of the curve on said circular or elliptical or sinusoidal motion when said tangent is substantially parallel to the desired direction and circular or elliptical or sinusoidal motion is substantially in desired direction.

Preferably, actuator is configured to oscillate said touchscreen at a frequency which is imperceptible by a human.

Preferably said touchscreen is contained within a housing which dampens the effect of oscillatory movement by said touchscreen.

Preferably, said friction coefficient is increased by electrical or electrostatic means including using an electrode under said touchscreen with an insulator between said electrode and touchscreen, wherein said insulator prevents flow of direct current from the conducting electrodes to object touching said touchscreen and a capacitive coupling over said insulator is formed between said conducting electrodes and the skin of said user which increases said friction coefficient.

Preferably, said touchscreen is mounted in a housing so that it can freely vibrate laterally in x and y directions at or significantly close to its natural resonant frequency.

Preferably, said resonant frequency needs to be the same in x and y directions.

Preferably, said method includes means to create static textures in different areas of the touchscreen.

Alternatively, said friction coefficient is increased by mechanical means including mechanically actuated protrusions on said surface.

Alternatively, wherein said object can be attracted by a magnetic force said friction coefficient may be increased by magnetic means.

More specific features for preferred embodiments are set out in the description below.

### OBJECTS OF THE INVENTION

It is an object of the present invention to provide an apparatus and method for producing lateral force on an object contacting a touchscreen.

It is a further object of the present invention to provide an apparatus and method which allows a plurality of lateral forces on a plurality of objects contacting a touchscreen.

It is a further object of this invention to provide an apparatus and method which allows the direction and amplitude of a lateral force on an object contacting a touchscreen to be varied.

Further objects and advantages of the present invention will be disclosed and become apparent from the following description. Each object is to be read disjunctively with the object of at least providing the public with a useful choice.

### BRIEF DESCRIPTION OF THE DRAWINGS

The invention will now be described by way of example only with reference to the accompanying drawings, in which:

FIGS. 1A to 1D show a series of side-views of the preferred embodiment of the invention to illustrate how a lateral force is produced.

FIGS. 2A to 2C show a series of top-views of the preferred embodiment of the invention to illustrate how a lateral force is produced.

FIGS. 3A to 3C show a series of top-views of an alternative embodiment of the invention to illustrate how a net lateral force is produced.

FIG. 4A shows a top view of an alternative embodiment of the invention to illustrate how net lateral forces in a plurality of different directions may be produced simultaneously.

FIG. 4B shows a top-view of the touchscreen illustrating movement to describe various oscillating shapes which can produce a net lateral force according to an alternative embodiment of the invention.

FIGS. 5A to 5C is a top-view of a touchscreen illustrating a preferred embodiment of the operation of the invention.

FIG. 6 is a top-view of a touchscreen with varying friction coefficients on its surface.

FIG. 7 is a top-view of a touchscreen with varying friction coefficients on its surface combined with a preferred embodiment of the operation of the invention.

FIG. 8 is a flow chart diagram showing a preferred embodiment of the operation of the invention.

### DETAILED DESCRIPTION OF THE INVENTION

Various embodiments of the present invention are described hereinafter with reference to the figures. It should be noted that the figures are only intended to facilitate the description of specific embodiments of the invention. In addition, an aspect described in conjunction with a particular embodiment of the present invention is not necessarily limited to that embodiment and can be practiced in any other embodiments of the present invention.

This invention allows for the synthesis of inertia or lateral force to be produced and felt by an appendage that is touching or manipulating objects on the touchscreen, which will allow very realistic feeling for objects on a touchscreen—for example, the flicking of a toggle switch displayed on the touchscreen, providing resistance and motion to a finger when stopping or slowing down a kinetically scrolling element on the display, or providing a feeling to a touchscreen joystick to make it feel like it is sprung towards the center (see FIGS. 5A to 5C below).

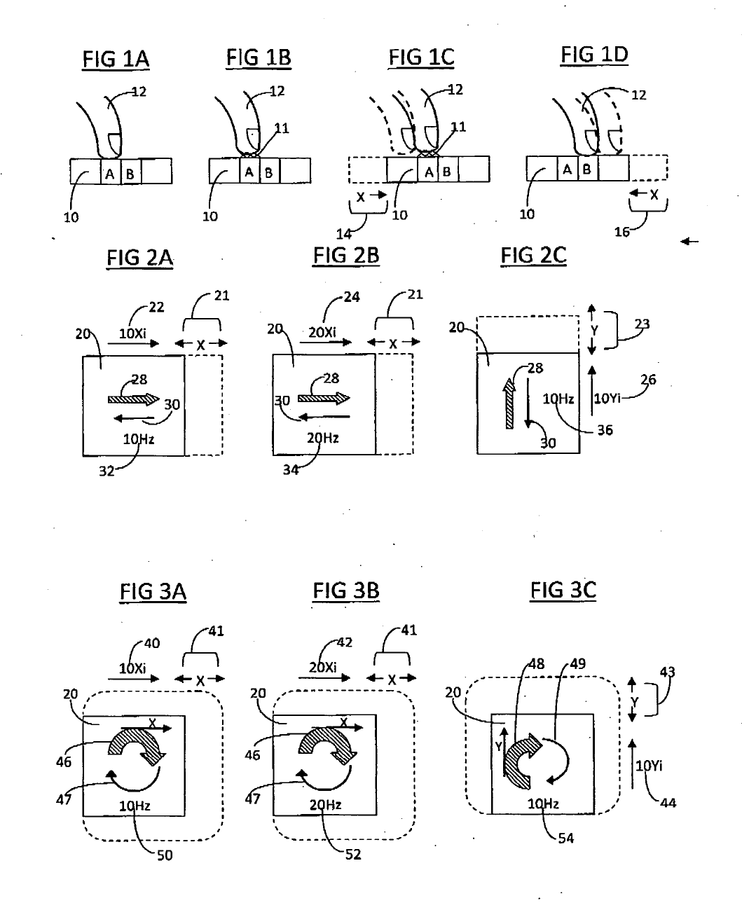

The invention works by combining the manipulation of the surface friction coefficient between the skin from a finger or other appendage, or a material designed to be worn over said appendage, and, optionally, if by moving the surface of the touchscreen in x and y directions to describe an oscillating line or circular/enclosed shape in any direction at a speed and amplitude that is imperceptible, or at least does not bother the user under normal operation, can be used to generate force feedback or a feeling of movement and/or inertia. The surface coefficient of friction of the touchscreen is modified by either using one or more actuators that can effect linear planar motion at high frequency—such as a solenoid or array of solenoids coupled to the touchscreen so as to effect x and y motion, an array of piezoelectric device capable of actuating at sonic and ultrasonic frequencies, a motor with a coupling or, preferably by using an alternating electrical field that is generated at the touchscreen or control surface, so as to generate an electric field between the finger of a user and the surface. This friction modulation is turned on and off so that it describes a vector where the friction is ‘on’ and where it is ‘off’ related to the movement of the surface (refer to FIGS. 1-4 below). The net effect of this, is that the object touching the surface of the display will move in a net direction described by the planar movement of the surface, and the points in time at which the friction coefficient is modified to be higher and lower between the surface and the appendage contacting the surface. The speed and direction of the movement will be approximated by the length of time the friction coefficient is high while the surface is moving in a particular direction and with a particular amplitude, multiplied by the frequency of the planar movement (refer to FIGS. 2 and 3 below). The force felt by the appendage will be variable dependent on the static friction of the display surface when the surface friction coefficient is modified to be at the ‘high’ state. It is also possible to configure the display surface to decrease or negate said friction coefficient when moving in directions other than the desired direction, which will have a similar net force effect on the appendage. For example, this be accomplished by vibrating the display surface ultrasonically, utilising the same principle as an ultrasonic knife, which is well known in the art. Preferably, the ultrasonic vibration of the touchscreen is also driven by a Piezoelectric stack actuator that creates the vibrations. Therefore, according to a preferred embodiment of the invention it is possible to modify the friction coefficient of the touchscreen, ultrasonic vibration to reduce the friction coefficient and alternating an electric field (e.g. coulomb effect) to increase the friction coefficient.

The invention can enable objects in contact with the touchscreen in multiple areas to experience independent synchronous lateral force. In particular, the invention can localise any force vector or movement by means of spatially localising in a time-varying way the modification of the surface friction coefficient between an appendage and the surface itself. In this way, it is possible to have multiple user interface elements displayed to the user, and the user being able to perceive that each has an independent motive element, inertia or force feedback, all of which can be used and felt synchronously if desired. It is possible to implement the localisation of a controlled friction coefficient in two ways—one is by using a spatially localised array of transparent ultrasonic actuators, for example, shear-mode actuators placed on the surface of the display or control surface. Another method to localise the friction coefficient modification in a controllable way is by using an array of elements that present an individually controlled time-varying electric field generated at the surface, at different points across the surface.

It is possible to employ any number of materials to manufacture the surface substrate in order to allow manipulation of the friction coefficient, and it will be apparent to those skilled in the art that a variety of techniques can be used to controllably increase the friction coefficient between an object and the touchscreen, including but not limited to electrical and electrostatic means (see above), mechanical means (including mechanically actuated protrusions for increasing surface ‘roughness’), and magnetic means (assuming the object can be attracted by a magnetic force). The preferred embodiment uses electrical and electrostatic means to vary the friction coefficient due to it being the most practical and efficient method at it allows the increased friction coefficient to be turned ‘off’ and ‘on’ at a high frequency (e.g. multiple thousands of Hz.).

To minimise energy use of the invention, so that it operates efficiently and requires a minimum amount of energy to effect the friction modification and motion of the surface of the touchscreen or control surface required (so that any battery powering the system is conserved), it is important to employ an efficient way to generate the lateral motion of the touchscreen. One method of doing this is to mount the surface of the display or control surface so that it can freely vibrate laterally in both x and y directions at, or close to, a natural resonant frequency. Optimally, the resonant frequency needs to be the same in x and y directions. This natural frequency will of course change depending on the damping that objects give it when contacting the touchscreen surface, but will still remain the frequency at which the surface of the touchscreen yields the largest motion and consumes the least power.

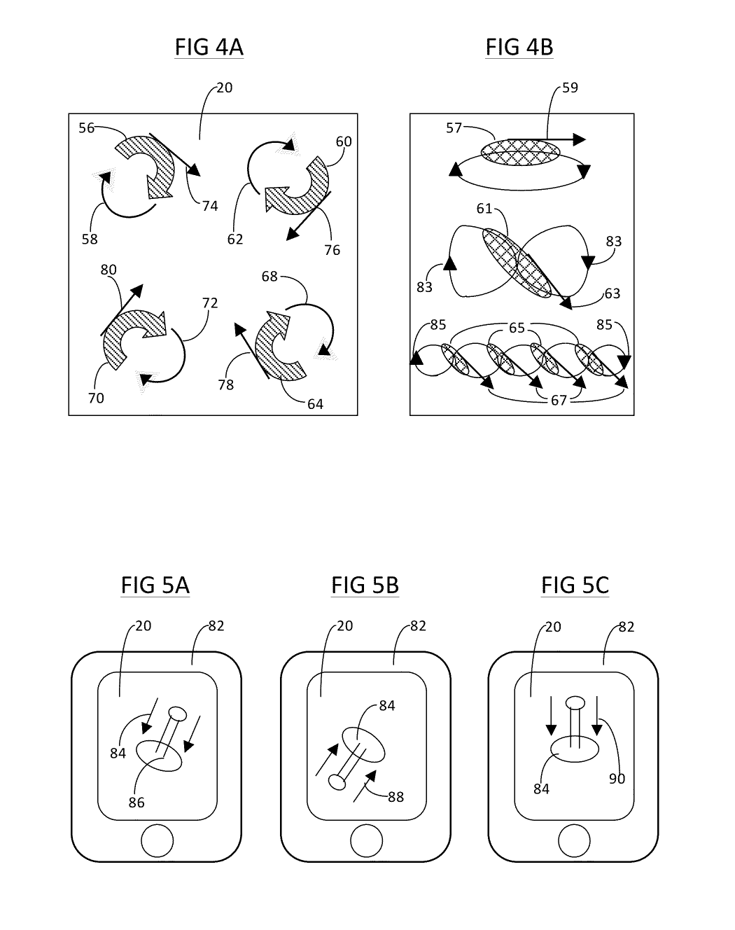

Movement of the touchscreen does not have to be circular (refer to FIG. 4B), and it is actually beneficial to have it describe a non-circular movement, just an oscillating line being generated by a single function generator that is sinusoidal, but can be rotated in any direction by altering the amplitude of in-phase x and y components, as well as the polarity. For example, if the phase is out by 90 degrees to describe a circle, then actually, it is likely to diminish any net force vector, since any net force will be actuated over an arc shape which has x and y components in it, the net force being in the direction of the tangent to the arc.

In an alternative embodiment, a lateral force can be effected by generating a ‘rotating’ electric fields in multiphase way—using an effect like that of a linear motor behind touchscreen and acting on object using very small field areas, so that when moved (rotated') using 3 or more phases, it results in a net force pulling the object in the direction of the alternating phasor. This would not require any physical movement of the actual touchscreen, but also may not necessarily actuate with quite the same force. These would be synthesized, by using small electric field coupling areas—the invention can use electric field coupling areas for the purposes of effecting planar tactile force feedback.

The features and operation of the preferred and alterative embodiments of the invention will now be illustrated with reference to FIGS. 1-8.

FIGS. 1A to 1D show a series of side-views of the preferred embodiment of the invention to illustrate how a lateral force is produced. The 4 figures represent a sequence showing how the invention generates a lateral force on an object (here shown as a finger 12) in the desired direction (rightwards) to get from position “A” to position “B” on a touchscreen 10. FIG. 1A shows the first series where a finger 112 contacts position “A” on the touchscreen 10. In the next series, FIG. 1B shows that an increased friction coefficient, represented by a zig-zag lines 11 has been applied to the touchscreen surface under the finger 12. In the next series FIG. 1C, the touch screen 10 is moved to the right by a distance X (14) resulting in a corresponding movement to the right on the finger 12 (as shown by the dashed lines of the finger) due to the increased friction coefficient 11 between the finger 12 and the touch screen 10. In the next series, FIG. 1D shows a corresponding movement back to the left by a distance X (16), however, this movement is not in the desired direction (leftwards), therefore the friction coefficient is reduced or negated and the touchscreen surface does not produce a leftward force on the finger 12, which results in the finger now being in position “B”. In a preferred embodiment of the invention, movement in the leftwards direction can be facilitated by decreasing or negating the friction coefficient of the surface, for example, using an ultrasonic vibration of the screen driven by a Piezoelectric stack actuator that creates the vibrations. The dashed lines next to the touchscreen show the range of motion according to the preferred embodiment. While FIGS. 1A to 1D illustrate the method of generating a force in a rightwards direction, it should be apparent to those skilled in the art that the disclosed method of modulating a friction coefficient of an oscillating surface can be used in order to exert a force on an object in contact with the touchscreen in any direction.

FIGS. 2A to 2C show a series of top-views of the preferred embodiment of the invention to illustrate how a lateral force is produced. These figures show a top view of a touchscreen 20 and illustrate how the same method explained in the series of FIGS. 1A-1D can be combined with an oscillation in the x or y direction at a certain frequency to generate an increasing net force in a particular direction with increasing frequency of oscillation. The dashed lines next to the touchscreen 20 show the range of motion according to the preferred embodiment. FIG. 2A shows a shaded arrow in the rightwards direction which illustrates an increased friction coefficient 28 between an object (not shown) and a touchscreen 20. Reference numeral 30 shows a plain arrow in the leftwards direction which represents a decreased or negated friction coefficient. As discussed above, according to a preferred embodiment of the invention, movement in the leftwards direction can be facilitated by decreasing or negating the friction coefficient of the surface, for example, using an ultrasonic vibration of the screen driven by a Piezoelectric stack actuator that creates the vibrations. When the touchscreen 20 oscillates to the right by distance X (21) there is an increased friction coefficient 28 and when the touchscreen is moving in the other direction there is a decreased or negated friction coefficient 30. If this left and right oscillation occurs at 10 Hz (32) then an object should experience a force of 10 Xi (22) in the rightwards direction. The constant “i” is a value representing the level of friction between the touchscreen and the object. This value may vary (as may depend on the conditions of the surface of the touchscreen and the net movement in the desired direction), so “i” is not a constant in the strict sense, however, it can be assumed to be to aid understanding in this specification. FIG. 2B shows a shaded arrow in the rightwards direction which illustrates an increased friction coefficient 28 between an object (not shown) and a touchscreen 20. Reference numeral 30 shows a plain arrow in the leftwards direction which represents a decreased or negated friction coefficient. When the touchscreen 20 oscillates to the right by distance X (21) there is an increased friction coefficient 28 and when the touchscreen is moving in the other direction there is a decreased or negated friction coefficient 30. If this left and right oscillation occurs at 20 Hz (34) then an object should experience a force of 20 Xi (24) in the rightwards direction. FIG. 2C shows a shaded arrow in the upwards direction which illustrates an increased friction coefficient 28 between an object (not shown) and a touchscreen 20. Reference numeral 30 shows a plain arrow in the downwards direction which represents a decreased or negated friction coefficient. When the touchscreen 20 oscillates in the upwards direction by distance y (23) there is an increased friction coefficient 28 and when the touchscreen is moving in the other direction there is a decreased or negated friction coefficient 30. If this upwards and downwards oscillation occurs at 10 Hz (36) then an object should experience a force of 10 Yi (22) in the upwards direction.

FIGS. 3A to 3C show a series of top-views of an alternative embodiment of the invention to illustrate how a net lateral force is produced. These figures illustrate a similar principle as FIG. 2 above, however, the oscillation is now in a closed circle shape rather than a line. The dashed lines next to the touchscreen show the range of motion according to the preferred embodiment. By increasing the friction coefficient when the net movement of the oscillation is in the desired direction and otherwise decreasing or negating the friction coefficient, a net force in the desired direction can be created, and such net force can be increased with increased frequency of oscillation. FIG. 3A shows a shaded arrow moving in a half-circle clockwise towards the rightwards direction which illustrates an increased friction coefficient 46 between an object (not shown) and a touchscreen 20. Reference numeral 47 shows a plain arrow moving in a half circle clockwise towards the leftwards direction which represents a decreased or negated friction coefficient. As discussed above, according to a preferred embodiment of the invention, movement clockwise in the leftwards direction can be facilitated by decreasing or negating the friction coefficient of the surface, for example, using an ultrasonic vibration of the screen driven by a Piezoelectric stack actuator that creates the vibrations. When the touchscreen 20 oscillates in a half circle in the clockwise direction by distance X (41) there is an increased friction coefficient 46 and when the touchscreen is moving in the other direction there is a decreased or negated friction coefficient 47. If this circular clockwise oscillation occurs at 10 Hz (50) then an object should experience a force of 10 Xi (40) in the rightwards direction. FIG. 3B shows a shaded arrow moving in a half-circle clockwise towards the rightwards direction which illustrates an increased friction coefficient 46 between an object (not shown) and a touchscreen 20. Reference numeral 47 shows a plain arrow moving in a half circle clockwise towards the leftwards direction which represents a decreased or negated friction coefficient. When the touchscreen 20 oscillates in a half circle in the clockwise direction by distance X (41) there is an increased friction coefficient 46 and when the touchscreen is moving in the other direction there is a decreased or negated friction coefficient 47. If this circular clockwise oscillation occurs at 20 Hz (52) then an object should experience a force of 20 Xi (42) in the rightwards direction. FIG. 3C shows a shaded arrow moving in a half-circle clockwise towards the upwards direction which illustrates an increased friction coefficient 48 between an object (not shown) and a touchscreen 20. Reference numeral 49 shows a plain arrow moving in a half circle clockwise towards the downwards direction which represents a decreased or negated friction coefficient. When the touchscreen 20 oscillates in a half circle in the clockwise direction by distance y (43) there is an increased friction coefficient 48 and when the touchscreen is moving in the other direction there is a decreased or negated friction coefficient 49. If this circular clockwise oscillation occurs at 10 Hz (54) then an object should experience a force of 10 Yi (44) in the upwards direction. It will be apparent to those skilled in the art that while the shaded arrows representing an increased friction coefficient are shaded for the entire half-circle, it may be desirable to ensure that the friction coefficient is increased for only a portion of the net movement in the desired direction in order to minimise the forces being applied to the object in undesirable directions. The preferred method for doing this would be to ensure an increasing friction coefficient around the apex of the half circle (thus ensuring the most force is applied to the object when the arc of the circle is moving closest to its tangent). However as this will result in decreased force being applied to the object overall, preferably, the frequency of oscillations should be increased to compensate.

FIG. 4A shows a top view of an alternative embodiment of the invention to illustrate how net lateral forces in a plurality of different directions may be produced simultaneously. In particular, FIG. 4A show 4 shaded half-circle arrows representing an increased friction coefficient (56, 60, 64, 70) where the tangents (74, 76, 78, 80, respectively) representing the net movement of the shaded half-circle arrows, point towards the centre of the touchscreen. Reference numerals 58, 62, 68, and 72, respectively, shows a plain arrows moving in a half circle clockwise towards the opposite directions which represents a decreased or negated friction coefficient. As discussed above, according to a preferred embodiment of the invention, movement in the opposite directions can be facilitated by decreasing or negating the friction coefficient of the surface, for example, using an ultrasonic vibration of the screen driven by a Piezoelectric stack actuator that creates the vibrations. This illustration of the preferred embodiment shows how lateral forces in different directions (namely, towards the centre of the touchscreen 20) can be applied to objects in contact with the different areas of the touchscreen 20. This will be felt by a finger as a force towards the centre, which can be used to emulate the feeling of a joystick (as illustrated in FIG. 5).

FIG. 4B shows a top-view of the touchscreen illustrating movement to describe various oscillating shapes which can produce a net lateral force according to an alternative embodiment of the invention. The first shape is an ellipse which oscillates in a clockwise direction with a shaded portion representing an increased friction coefficient 57 which generates a net force in the rightwards direction 59. The second lemniscate-type shape oscillates in the direction indicated by arrows 83 with a shaded portion representing an increased friction coefficient 61 which generates a net force in a diagonal direction 63. The third closed ribbon shape oscillates in the direction indicated by arrows 85 with shaded portions representing an increased friction coefficients 65 which generates a net force in a diagonal direction 67. It will be apparent to those skilled in the art that the possible oscillating shapes capable of producing a lateral force on an object are not limited to the examples shown.

FIGS. 5A to 5C is a top-view of a touchscreen illustrating a preferred embodiment of the operation of the invention. The Figures illustrate the operation of a virtual joystick 84 on a touchscreen 20. The virtual joystick can be manipulated by a finger by touching the top of the joystick and moving it away from the centre. The invention using the principle illustrated in FIG. 4A can produce a different lateral force on the finger in order to provide a sensation of force back towards the centre of the joystick. This creates tactile feedback on the touchscreen 20 which simulates a real joystick. For example, as shown in FIG. 5A, when the virtual joystick 84 is moved diagonally upwards by a finger pressing on the top of the joystick (not shown) the invention produces a corresponding force in the opposite direction 86. As shown in FIG. 5B, when the virtual joystick 84 is moved diagonally downwards by a finger pressing on the top of the joystick (not shown) the invention produces a corresponding force in the opposite direction 88. As shown in FIG. 5C, when the virtual joystick 84 is moved upwards by a finger pressing on the top of the joystick (not shown) the invention produces a corresponding force in the opposite direction 90. It should be noted that according to the preferred embodiment, the touchscreen 20 is contained within a device with a housing 82 which is configured to damp any transfer of oscillatory force on the holder of the device. As discussed above, preferably, the touchscreen is contained in a housing 82 so that it can freely vibrate laterally in x and y directions at or significantly close to its natural resonant frequency.

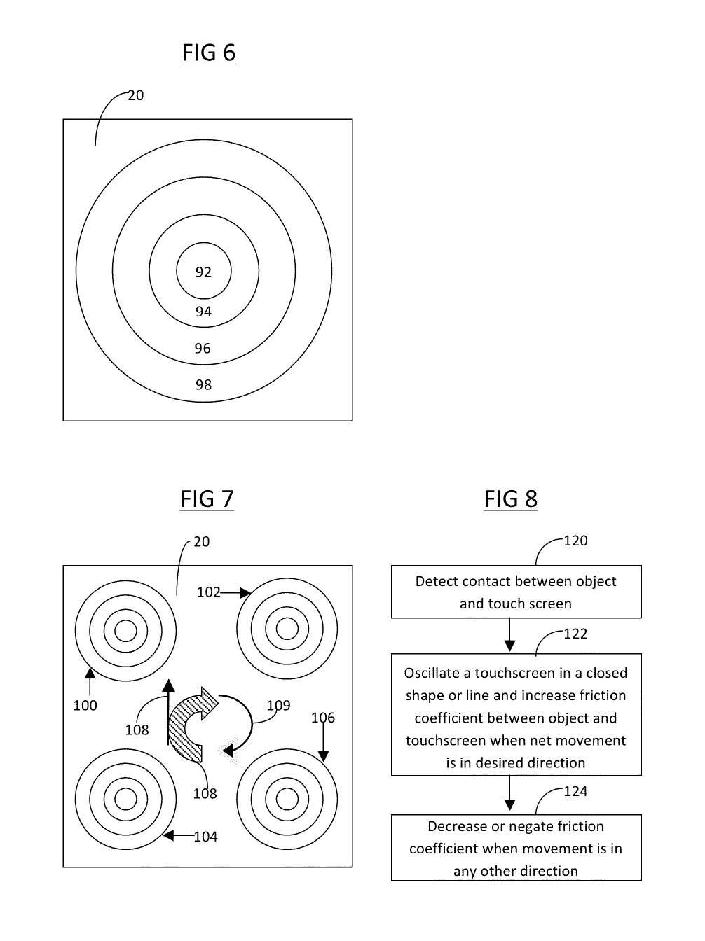

FIG. 6 is a top-view of a touchscreen 20 with varying friction coefficients in different locations (92, 94, 96, 98). Means to create static textures in different areas of the touchscreen are used on the preferred embodiment of the invention. These means are well known in the art, for example, under the principle of capacitative coupling, an insulator between the skin and electrode can be used to create a localised sensation or feeling of pressure (refer to U.S. Pat. Nos. 7,924,144, 7,982,588, and 8,174,373 by Senseg Limited, which are hereby incorporated by reference). The electrical range where Pacinian corpuscles (pressure sensors) are stimulated is a frequency range between 10-1000 Hertz, preferably between 50-500 and optimally between 100-300, e.g. 240 Hz. This will produce a sensation of apparent vibration. An alternating electric field (e.g. coulomb effect) can also be used to increase the friction coefficient of the touchscreen in a static manner (as opposed to modifying the friction coefficient in a dynamic manner in combination with movement of the touchscreen, which creates a force on an object according to the invention disclosed in this specification).

FIG. 7 is a top-view of a touchscreen 20 with varying friction coefficients on its surface in different locations (100, 102, 104, 106) combined with a preferred embodiment of the operation of the invention. In particular, a combination of varying the friction coefficient in different parts of the touchscreen might be useful to provide tactile feedback which corresponds to different ‘textures’. This can be combined with the lateral forces produced by the invention, for example, using the oscillating shape with a shaded half-circle arrows representing an increased friction coefficient 108 to produce a lateral force in a desired direction 110. This will produce a touchscreen which can provide feedback to a user including texture and a feeling of inertia or force.

FIG. 8 is a flow chart diagram showing a preferred embodiment of the operation of the invention. In the first step 120, the invention detects contact between an object and touchscreen. In the next step 122, the invention will oscillate touchscreen and increase friction coefficient between said object and touch screen when net movement occurs in the desired direction. In the final step 124, the invention will decrease or negate friction coefficient when movement is in any other direction. The operation of the invention allows a net movement in the desired direction proportional to the frequency of oscillation and level of friction between the object and the touch screen.

While the invention has been illustrated and described in detail in the foregoing description, such illustration and description are to be considered illustrative or exemplary and non-restrictive; the invention is thus not limited to the disclosed embodiments. Features mentioned in connection with one embodiment described herein may also be advantageous as features of another embodiment described herein without explicitly showing these features. Variations to the disclosed embodiments can be understood and effected by those skilled in the art and practicing the claimed invention, from a study of the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. An apparatus for producing a lateral force on a touchscreen comprising:
an actuator configured to oscillate a touchscreen in any lateral direction;
a processor configured to increase the friction coefficient between an object and said touchscreen when the net movement of said touchscreen occurs in a pre-determined direction;
whereby a net lateral force in said pre-determined direction may be produced upon an object in contact with said touchscreen.

2. The apparatus of claim 1, wherein said processor is configured to decrease or negate said friction coefficient when said touchscreen is moving in a direction other than said pre-determined direction.

3. The apparatus of claim 1, wherein said actuator is configured to oscillate touchscreen in an ultrasonic manner.

4. The apparatus of claim 1, wherein said processor is configured to substantially increase said the frequency and/or amplitude of said oscillation, whereby a substantially increased lateral force in the pre-determined direction may be produced upon an object contacting said touchscreen.

5. The apparatus of claim 1, wherein said actuator is configured to oscillate said touchscreen in a substantially circular or elliptical or sinusoidal motion.

6. The apparatus of claim 1, wherein said touchscreen is mounted in a housing so that it can freely vibrate laterally in x and y directions at or significantly close to its natural resonant frequency.

7. The apparatus of claim 1, wherein said friction coefficient is increased by electrical or electrostatic means including using an electrode under said touchscreen with an insulator between said electrode and touchscreen, wherein said insulator prevents flow of direct current from the conducting electrodes to object touching said touchscreen and a capacitive coupling over said insulator is formed between said conducting electrodes and the skin of said user which increases said friction coefficient.

8. The apparatus of claim 1, wherein said friction coefficient is increased by mechanical means including mechanically actuated protrusions on said surface.

9. The apparatus of claim 1, wherein said object can be attracted by a magnetic force said friction coefficient may be increased by magnetic means.

10. A method for producing a lateral force on a touchscreen comprising the steps of:
detecting contact between an object and a touchscreen;
oscillating a touchscreen in any lateral direction;
increasing friction coefficient between object and touchscreen when net movement is in a pre-determined direction;
decreasing or negating friction coefficient when movement is in any other direction other than pre-determined direction.
